(19) United States
(12) Patent Application Publication
(10) Pub. No.: US 2004/0062408 A1
(43) Pub. Date: Apr. 1, 2004

(54) Communication device

(76) Inventor: Michael F. Jorgensen, Hellerup (DK)

Correspondence Address: Dykema Gossett, Suite 300 West, 1300 I Street NW, Washington, DC, 20005-3306, US

(21) Appl. No.: 10/450,684

(22) PCT Filed: Dec. 19, 2001
(86) PCT No.: PCT/DK01/00843

(30) Foreign Application Priority Data
Dec. 20, 2000 (DK) PA2000019134

(51) Int. Cl. H04R 25/00

(52) U.S. Cl. 381/323; 381/312

(57) ABSTRACT

The invention relates to a communication device comprising a housing in which a battery drawer for accommodating a circular battery is mounted pivotally and in which means for preventing unintended removal of the battery are provided. The battery drawer comprises two side elements for preventing gripping of the essentially planar sides of the battery and an aperture intended for insertion of an object for pressing the battery out of the battery drawer. The invention further relates to a battery drawer for use in a communication device.

### FIELD OF THE INVENTION

The invention relates to a communication device comprising a housing in which a battery drawer is mounted pivotally and in which a means for preventing unintended removal of the battery is provided. Such devices comprise hearing aids, headsets and similar personal communication devices.

### BACKGROUND OF THE INVENTION

Such communication device is previously known from CH 688925. In the hearing aid disclosed in this prior art publication the means for preventing unintended opening of the battery drawer comprises a slidably mounted pin element, which is slidable into a corresponding blind hole in the housing. This previously known locking means requires an accurate positioning of the battery drawer in relation to the housing. Furthermore there is a risk of unintended breaking of the pin element in case this is slided into the locking position when the battery drawer is open and the battery drawer afterwards is closed. This and other mechanical problems are the result of the relatively small dimensions of such communication device parts. Still further the locking mechanism always has to be actively actuated for the intended functioning. The user often forgets this.

The objective of the present invention is to provide a communication device aid of the above-mentioned type, which has a reduced risk of breaking the locking means or other mechanical failure and which does not require the separate locking operation by the user in order to function correctly.

### SUMMARY OF THE INVENTION

The objective of the invention is achieved by means of a communication device of the type defined in claim 1.

In this manner a child safe accommodation of a battery in a communication device may be achieved. The construction comprises no mutually movable parts, which contribute significantly to the reliability of the construction. The secure placement of the battery will take inherent take place by insertion of this between the two side elements, wherefore the user will not forget to activate any safety mechanism and the removal of the battery is achieved in an easy and controlled manner with a reduced risk of dropping the battery during this process.

The invention will be described more detailed in the following with reference to the drawings.

### BRIEF DESCRIPTION OF THE DRAWINGS

FIG. 1 is a perspective view of a hearing aid according to the invention;

FIG. 2 is a rear view of the hearing aid of FIG. 1, with the battery drawer in a open position;

FIG. 3 is a perspective view of a battery drawer with a battery;

FIG. 4 is a perspective view of a battery drawer with a battery;

FIG. 5 is a perspective view of a battery drawer without battery;

FIG. 6 is a perspective view of a battery drawer without battery;

### DESCRIPTION OF THE PREFERRED EMBODIMENT

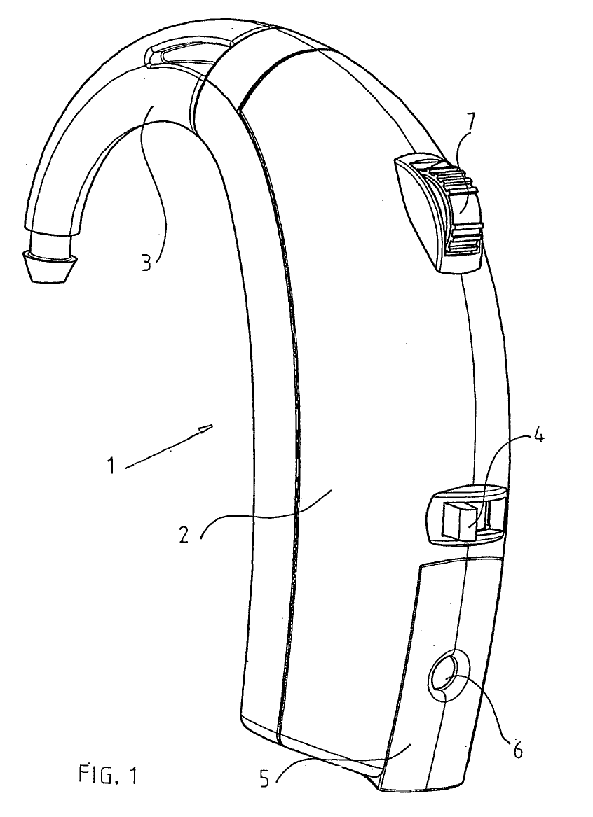

From FIG. 1 a communication device in the form of a hearing aid 1 appears, which comprises a housing 2. At one end the housing carries a so-called hook 3 and at the opposite end a battery drawer 5 is provided. An aperture 6 is provided in the battery drawer. Furthermore a switch 4 and a volume control 7 are provided, however these elements have no effect as such on the present invention.

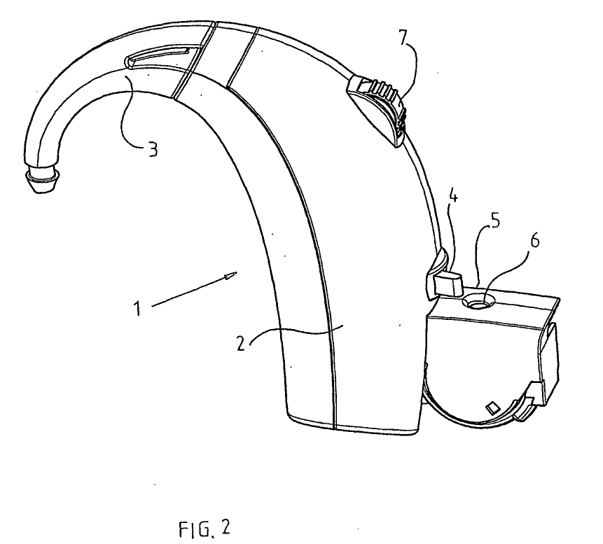

From FIG. 2 the same hearing aid 1 appears is a situation where the battery drawer 5 has been pivoted in relation to the housing 2. The aperture 6 in the battery drawer is still accessible in this position of the battery drawer.

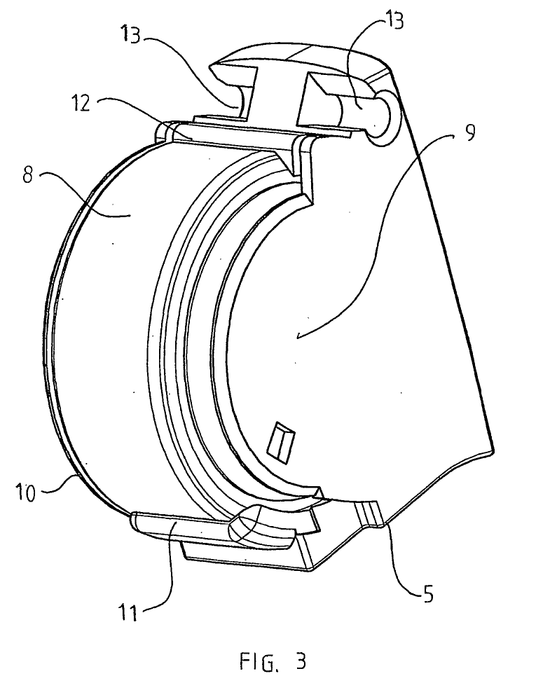

From FIG. 3 a battery drawer is shown in a state where this has been separated from the hearing aid housing. A circular battery 8, a so-called button cell, appears in a position where this is inserted in the battery drawer 5 and where the circular circumference of the battery is held by mutually opposed holding means 11,12, where at least one of these, in this case the holding means 11, may be flexed to allow insertion as well as removal of the battery 8. The distance between the outer ends of the holding means 12,13 is smaller than the diameter of the battery in order to maintain the battery in the battery drawer. The sides of the battery are covered by side parts 9,10 of the battery drawer, which side parts prevent gripping of the battery sides for removal of the battery. Recesses 13 for accommodating shaft parts in the hearing aid housing are provided.

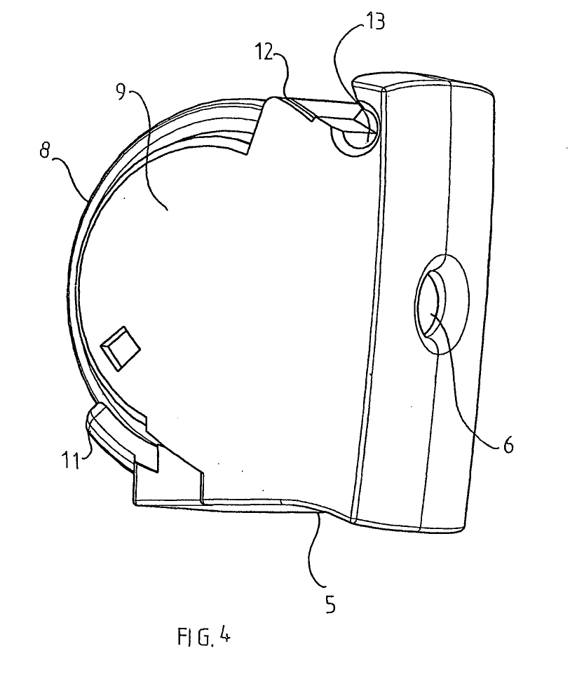

From FIG. 4 the battery drawer 5 appears in another view where the aperture 6 is visible. For removal of the battery an object having measures smaller than the aperture 6 is inserted through the aperture 6 and the battery is forced out of the battery drawer by overcoming the holding force of the holding means 11,12.

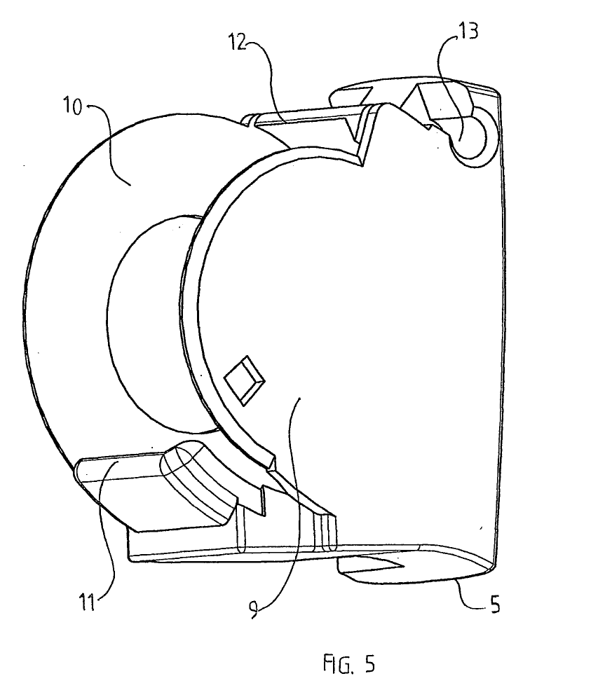

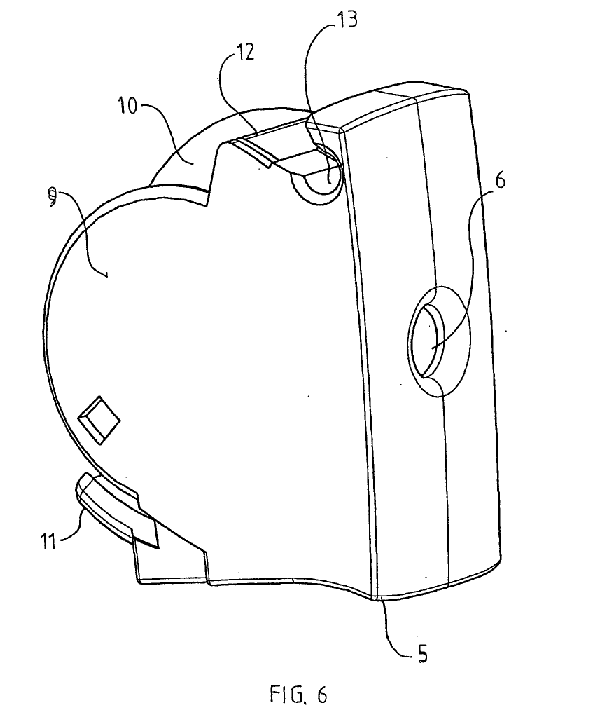

From FIG. 5 and FIG. 6 the battery drawer is shown without the battery. The side elements 9,10 appear clearer as well as the flexible holding means 11. The holding means could comprise two flexible arms without influencing the functionality of the invention

The battery drawer could be mounted with a fixed shaft that would make the connection between the housing and the battery drawer more rigid and secure.

1. A communication device comprising a housing in which a battery drawer for accommodating a circular battery is mounted pivotally and in which means for preventing unintended removal of the battery are provided, characterized in that the battery drawer comprises two side elements for preventing gripping of the essentially planar sides of the battery and an aperture intended for insertion of an object for pressing the battery out of the battery drawer.

2. A communication device according to claim 1, where holding elements are provided in the battery drawer for holding the battery on the circular circumference.

3. A communication device according to claim 2, where two holding elements are provided with a mutual distance smaller than the diameter of the battery.

4. A communication device according to claim 1,2 or 3, where in at least one of the side elements an opening is provided for establishing electrical contact with a battery pole.

5. A communication device according to claim 1,2 or 3, where in at least one of the side elements an incision is provided for establishing electrical contact with a battery pole.

6. A communication device according to any of the preceding claims, where the entire area of the surfaces circumscribed by the circular rim is covered by the side elements.

7. A battery drawer for use in a communication device comprising a housing in which a battery drawer for accommodating a circular battery is mounted pivotally and in which means for preventing unintended removal of the battery are provided, characterized in that the battery drawer comprises two side elements for preventing gripping of the essentially planar sides of the battery and an aperture intended for insertion of an object for pressing the battery out of the battery drawer.

8. A battery drawer according to claim 7, where holding elements are provided in the battery drawer for holding the battery on the circular circumference.

9. A battery drawer according to claim 8, where two holding elements are provided with a mutual distance smaller than the diameter of the battery.

10. A battery drawer according to claim 7, 8 or 9, where in at least one of the side elements an opening is provided for establishing electrical contact with a battery pole.

11. A battery drawer according to claim 7, 8 or 9, where in at least one of the side elements an incision is provided for establishing electrical contact with a battery pole.

12. A battery drawer according to any of the preceding claims, where the entire area of the surfaces circumscribed by the circular rim is covered by the side elements.
